(19) United States
(12) Patent Application Publication
(10) Pub. No.: US 2011/0149437 A1
(43) Pub. Date: Jun. 23, 2011

(54) METHOD AND APPARATUS FOR READ AND WRITE DATA IN A DISK DRIVE WITH DISCRETE TRACK DISK

(75) Inventor: Kazuto KASHIWAGI, Ome-shi (JP)

(73) Assignee: KABUSHIKI KAISHA TOSHIBA, Tokyo (JP)

(21) Appl. No.: 12/870,265

(22) Filed: Aug. 27, 2010

(30) Foreign Application Priority Data
Dec. 21, 2009 (JP) 2009-289636

(51) Int. Cl. G11B 5/127

(52) U.S. Cl. 360/110; 29/603.03; G9B/5.04

(57) ABSTRACT

According to one embodiment, a disk drive includes a disk and a data read/write module. The disk has a disk substrate, tracks and non-recording areas. The tracks and the non-recording areas are formed on the disk substrate and arranged in the radial direction of the disk. The tracks are magnetic layers and have a recording area each. The non-recording areas are made of non-magnetic layers and arranged between the tracks. Thus, valid recording area and invalid recording areas are provided in each track, at a predetermined ratio. The data read/write module is configured to write data in or read data from the valid recording areas, but not in or from the invalid recording areas.

### CROSS-REFERENCE TO RELATED APPLICATIONS

This application is based upon and claims the benefit of priority from Japanese Patent Application No. 2009-289636, filed Dec. 21, 2009; the entire contents of which are incorporated herein by reference.

### FIELD

Embodiments described herein relate generally to a disk drive which uses a discrete track disk.

### BACKGROUND

In recent years, disk drives using disks of the discrete track recording (DTR) system have been developed in the field of disk drives a representative example of which is the hard disk drive. The discrete track disk may hereinafter be referred to as a “DTR disk,” in some cases.

A DTR disk has data tracks and non-recording areas. The data tracks (data recording areas in which data can be magnetically recorded) are made of magnetic layers. The non-recording areas are arranged between the data tracks and are made of non-magnetic layers. The non-recording areas are regions equivalent to gaps or guard bands, in which magnetic data recording cannot be achieved. Since the data tracks are formed, each physically discrete with respect to any other, the magnetic interference between any adjacent tracks can be suppressed. The DTR system is therefore a technique that can validly realize high-density recording.

However, the DTR disk is a recording medium that has a predetermined track density measured in the radial direction of the disk. Hence, in the step of incorporating the disk and the magnetic head (hereinafter called “head”) in the disk drive during the manufacture of the disk drive, the recording magnetic field of the head (i.e., the recording width or track width) may be broader than the width designed for the track and measured in the radial direction of the disk. This is because of the deviation of the head characteristics from the design values. Since the data tracks are physically configured, the track density cannot be adjusted in accordance with the recording width of the head.

If the disk has a continuous film on which a magnetic layer is formed on the entire surface, data may be written in every other track in order to reduce the influence of leakage magnetic field to an adjacent track. (See, for example, Jpn. Pat. Appln. KOKAI Publication No. 2004-273060.) This method is indeed useful if the tracks actually used as data recording areas are half the number of all tracks formed on the disk. If all tracks formed on the disk are used as data recording areas, however, the method is scarcely useful.

In any disk drive using a DTR disk, the track density cannot be adjusted if the recording width of the head is greater than the design track width (measured in the radial direction of the disk), in the step of incorporating the disk and the magnetic head into the disk drive during the manufacture of the disk drive. Consequently, any head that has a recording width greater than the design track width has hitherto been discarded as defective.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing the major components of a disk drive according to an embodiment;

FIG. 2 is a diagram illustrating the configuration of a DTR disk for use in the embodiment;

FIG. 3 is a diagram illustrating the major parts of the DTR disk for used in the embodiment;

FIGS. 4A, 4B and 4C are diagrams illustrating the configuration of a servo area according to the embodiment;

FIG. 5 is a diagram illustrating a first method of recording data, according to the embodiment;

FIG. 6 is a diagram illustrating a second method of recording data, according to the embodiment;

FIG. 7 is a diagram illustrating a third method of recording data, according to the embodiment;

FIG. 8 is a diagram illustrating a method of reproducing data from a valid recording area, according to the embodiment;

FIG. 9 is a flowchart illustrating a method of recording and reproducing data, according to the embodiment;

FIG. 10 is a diagram showing the result of inspecting the track width in the embodiment;

FIG. 11 is a diagram showing another result of inspecting the track width in the embodiment;

FIG. 12 is a diagram showing still another result of inspecting the track width in the embodiment;

FIG. 13 is a flowchart outlining a method of manufacturing the disk drive according to the embodiment; and

FIGS. 14A and 14B are diagrams illustrating a method of setting a track density.

### DETAILED DESCRIPTION

Various embodiments will be described hereinafter with reference to the accompanying drawings.

In general, according to one embodiment, a disk drive includes a disk and a data read/write module. The disk has a disk substrate, tracks and non-recording areas. The tracks and the non-recording areas are formed on the disk substrate and arranged in the radial direction of the disk. The tracks are magnetic layers and have a recording area each. The non-recording areas are made of non-magnetic layers and arranged between the tracks. Thus, valid recording area and invalid recording areas are provided in each track, at a predetermined ratio. The data read/write module is configured to write data in or read data from the valid recording areas, but not in or from the invalid recording areas.

(Configuration of the Disk Drive)

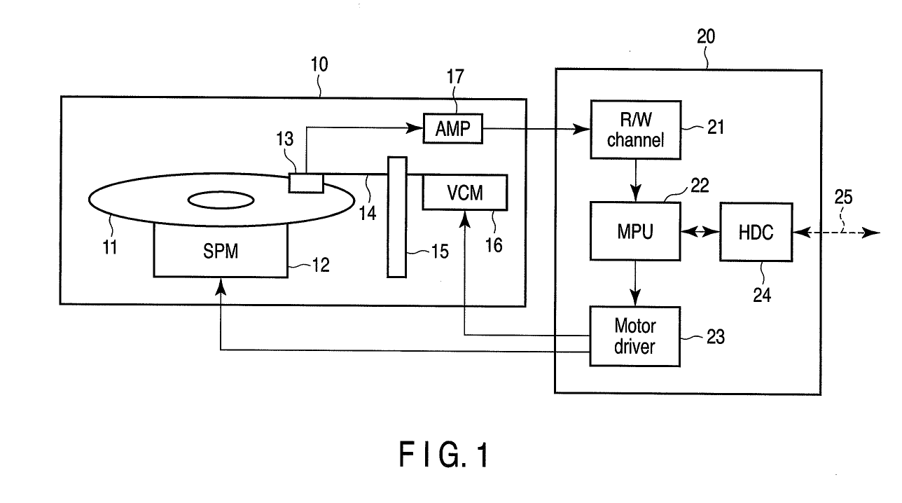

FIG. 1 is a block diagram showing the major components of a disk drive according to an embodiment.

As shown in FIG. 1, the disk drive is composed mainly of a drive mechanism unit also known as head disk assembly (HAD) 10 and a circuit unit mounted on a printed circuit board (PCB) 20. The HAD 10 has a discrete track disk, a spindle motor (SPM) 12, a head 13, and a head amplifier integrated circuit 17. The disk (hereinafter referred to as “DTR disk”) 11 has been processed, having both sides used as discrete track recording medium surfaces.

The spindle motor 12 rotates the DTR disk 11. The head 13 has a slider, a read head element (TMR element), and a write head element. The read head element and the write head elements are mounted on the slider and spaced apart from each other. The slider, i.e., main unit of the head, has a region that faces the surface of the disk 11 and shaped like a rectangle, having one side 1 mm long. Although one head 13 is shown in FIG. 1, at least two heads are provided in most disk drives, one head opposed to one side of the DTR disk 11, and the other head opposed to the other side of the DTR disk 11.

The head 13 is mounted on an actuator, which is a mechanism configured to move the head 13. The actuator has an arm 14, a pivotal pin 15, and a voice coil motor (VCM) 16. The arm 14 has a suspension that holds the head 13. The pivotal pin 15 is a member that allows the arm 14 to rotate freely. The VCM 16 imparts a rotation torque to the arm 14, causing the arm 14 to move the head 13 in the radial direction of the DTR disk 11.

The head amplifier 17 is configured to amplify any signal input to or output from the head 13 and transfers the signals between the head 13 and the PCB 20. One of these signals is a read signal (reproduced data) supplied from the read head element of the head 13, and the other of these signals is a write signal (record data) to be supplied to the write head element of the head 13. The head amplifier 17 is mounted on a flexible cable (FPC, not shown) and electrically connected to the PCB 20. In most cases, the head amplifier 17 is secured to the arm 14 in order to reduce the noise in the signal input to or output from the head 13. Nonetheless, it may be secured to any other component of the HAD 10.

The PCB 20 incorporates various integrated circuits, such as a read/write (R/W) channel 21, a microprocessor (MPU) 22, a motor driver 23, and a disk controller (HDC) 24. These integrated circuits may be formed in a single chip, constituting an LSI.

The R/W channel 21 is a circuit for processing head signals and serves to achieve read/write process, and switches the channels of the head amplifier 17 and processes read signals and write signal. To be more specific, R/W channel 21 demodulates a read signal supplied from the head amplifier 17 back to the record data. Further, the R/W channel 21 modulates the record data transferred from the HDC 24 to a write signal, which is supplied to the head amplifier 17.

The MPU 22 is the controller of the disk drive system, and serves as a head positioning control system (servo control system) in the present embodiment. The MPU 22 is composed of a central processing unit (CPU), memories such as a ROM and a RAM, and various logic circuits. The logic circuits are composed of hardware circuits, including an arithmetic circuit that performs arithmetic operations at high speed. The ROM holds the firmware the CPU may execute.

The motor driver 23 is a drive control unit configured to control the SPM 12 and VCM 16. Controlled by the MPU 22, the motor driver 23 supplies drive currents to the SPM 12 and VCM 16, driving and controlling the SPM 12 and VCM 16.

The HDC 24 is an interface provided in the disk drive, and is connected to, for example, an interface 25 of the serial ATA (SATA) standards, which in turn is connected to a host system (e.g., personal computer). The HDC 24 is a drive management unit that controls the data transfer between the disk drive and the host system and achieves data exchange between the MPU 22, R/W channel 21 and motor driver 23.

(Configuration of the DTR Disk)

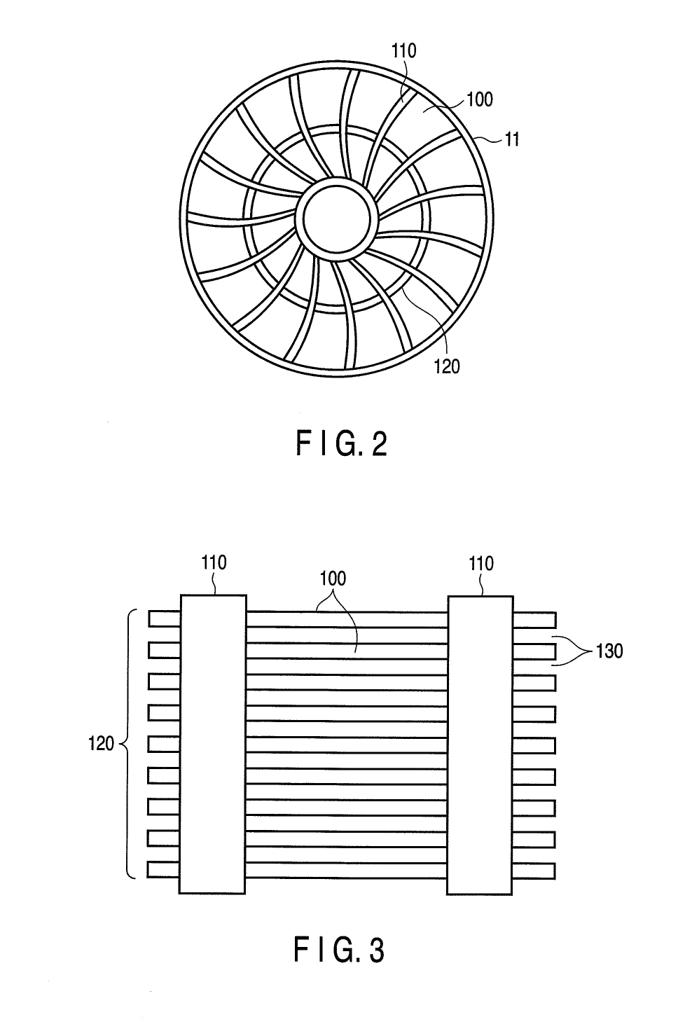

FIGS. 2 and 3 are diagrams that show the configuration of the DTR disk 11 used in this embodiment.

As shown in FIG. 2, the DTR disk 11 has data recording areas 100 and servo areas 110, in the main. The data recording areas 100 are regions in which user day may be recorded, and provided in concentric circular tracks 120.

As FIG. 3 shows, each track 120 is composed of servo tracks 110, data recording areas 100, and non-recording areas 130 arranged between the tracks. The data recording areas 100 are physical patterns, each being a magnetic layer, and are recording areas for holding user data. (Hereinafter, the data recording areas 100 will be called “data tracks” in some cases.) On the other hand, the non-recording areas 130 are non-magnetic layers, and are patterns equivalent to gaps or guard bands, in which data cannot be magnetically recorded. That is, the tracks 120 are physical track patterns arranged at a prescribed pitch (track pitch) in the radial direction of the disk 11. Each track pattern is composed of many data recording areas 100 and many non-recording areas 130 interposed between the data recording areas 100. Note that the data tracks 100 are also known as “record tracks.”

Each servo area 110 is a physical pattern for recording servo data used to control the head positioning, and is composed of a recording area (magnetic layer) and a non-recording area (non-magnetic layer). As shown in FIG. 2, the servo area 110 is arcuate, being an access locus of the head 13. The more remote from the center of the disk 11, the longer the servo area 110.

The data recording areas 100 and servo areas 110 of the DTR disk 11 according to this embodiment are physical patterns, each composed of a recording area (magnetic layer) and a non-recording area (non-magnetic layer). The recording area and the non-recording area may differ in the thickness of layer or characteristic change in layer, e.g., the crystal state of layer. If the recording area and the non-recording area differ in the thickness of layer, the recess of the magnetic layer (i.e., recording area) may be filled with non-magnetic material, thereby imparting a flat surface to the disk 11 and forming a non-recording area in which data cannot be magnetically recorded.

Like most disks, the DTR disk 11 may have data recording areas 100 and servo areas 110 on both surfaces. In this case, the DTR disk 11 is incorporated into the disk drive, with the orbit in which the head 13 almost aligned with the arcuate servo areas 110 moves, on both surfaces of the DTR disk 11. Moreover, the DTR disk 11 is based on such specification that each servo area 110 is arcuate, having an arc center on a circle which has a radial position, i.e., distance between the center of the disk 11 and the axis of the pivotal pin 15, and which an arc radius, i.e., distance between the pivotal pin 15 and the head 13.

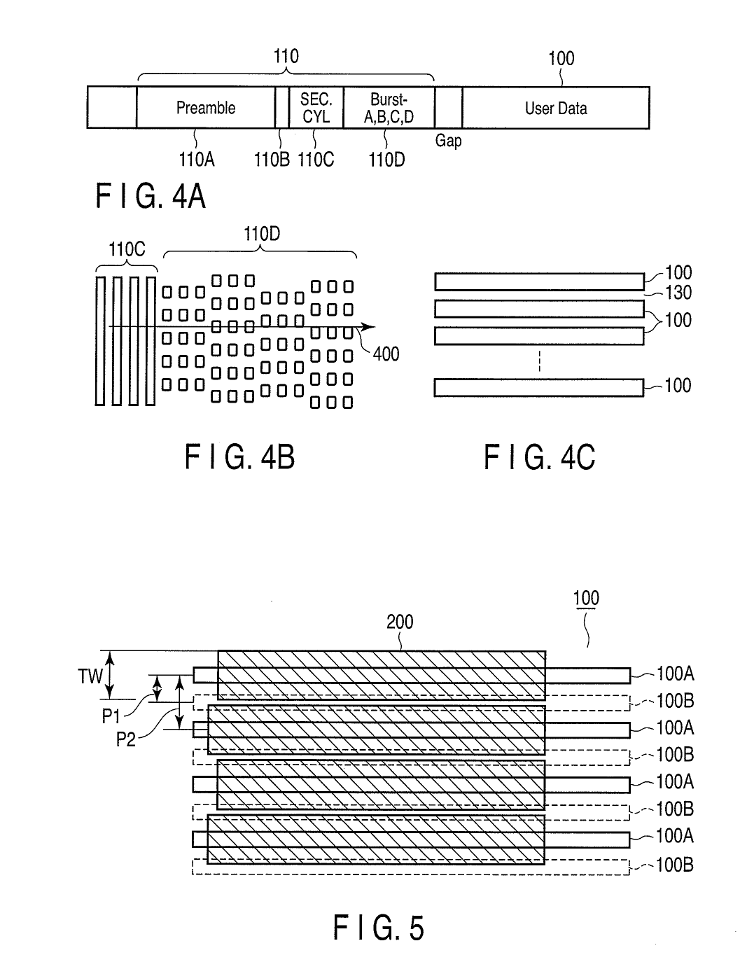

FIGS. 4A and 4B are diagrams showing the pattern configuration of each servo area 110. As seen from FIG. 4C, the servo areas 110 divides a track into, for example, 100 or more sectors, i.e., data recording areas 100, in the circumferential direction of the disk 11.

As shown in FIG. 4A, each servo area 110 includes a preamble 110A, a servo mark 110B, address data 110C, and a servo burst signal 110D. The preamble 110A holds a sync clock signal that performs a PLL process of synchronizing the clock signal used to reproduce servo data and an AGC process of maintaining the reproduced signal at appropriate amplitude. The preamble 110A is an almost arcuate pattern, not split in the radial direction of the disk 11 and composed of magnetic and nonmagnetic segments alternately arrange in the circumferential direction of the disk 11.

The servo mark 110B is a code for identifying the region that holds the servo data composed of the address data 110C and servo burst signal 110D. The address data 110C contains a servo address and a track (cylinder) address. The servo burst signal 110D is a region in which the head 13 detects the off-track value, i.e., deviation of the head 13 from the on-track position that the track address designates. The servo burst signal 110D is generally called as “A-to-D burst” and represents four patterns, i.e., four phases measured in different diameter directions of the disk 11.

The servo control system, or MPU 22, finds the average amplitude of the signals reproduced from bursts A to D, thereby calculating the off-track value of the head 13 that moves relative to the disk 11 in the rotational direction of the disk 11 (see arrow 400 shown in FIG. 4B).

(Methods of Recording Data)

Methods of recording data on the DTR disk 11 in the present embodiment will be explained, with reference to FIGS. 5 to 8.

First, a first method of recording data on the DTR disk 11 will be explained with reference to FIG. 5.

In the present embodiment, the disk 11 has data tracks (recording areas) 100, which are physical patterns arranged at a prescribed pitch (arrangement pitch) P1 as shown in FIG. 5. Of the data tracks 100, some are valid recording areas 100A, and the others are invalid recording areas 100B. The valid recording areas 100A are data tracks in which data may be recorded. The invalid recording areas 100B are data tracks in which data can be recorded, but which are invalid as data recording areas.

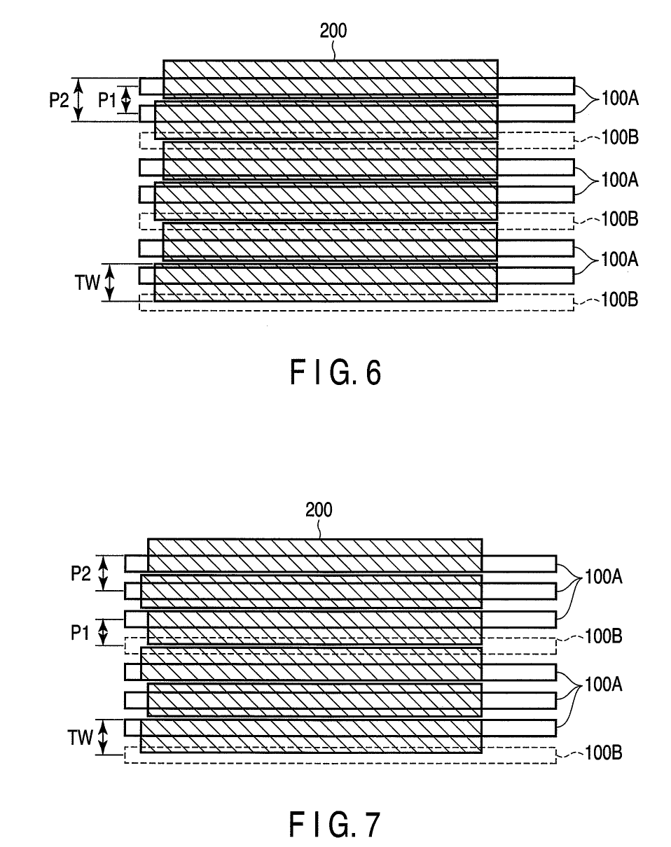

Assume that the write head element of the head 13 applies a recording magnetic field 200 to the disk 11 at a pitch P2. The recording magnetic field 200, including a leakage magnetic field, acts on the disk 11, over a track width TW (i.e., record width) measured in the radial direction of the disk 11. Here, the track width TW is defined as a minimum width (range) over which the data would not lost when the recording magnetic field 200 modulated with the write data is applied at the radial position r in a linear direction. The track width TW is regarded as a physical length that depends on the design precision of the head 13. The terms “pitch P1,” “pitch P2” and “track width TW” will be also used to explain the other data recording methods illustrated in FIGS. 6 to 8.

The disk drive according to this embodiment records data in the data tracks 100 as shown in FIG. 5, under the conditions “P1<P2” and “P1<TW.” Since P1<P2, the recording magnetic field 200 covers a plurality of data tracks 100. Therefore, effective data cannot be recorded in all data tracks.

In view of this, the disk drive according to this embodiment sets some of the data tracks 100 as valid recording areas 100A, and the other data tracks 100 as invalid recording areas 100B. More specifically, the MPU 22 stores, in a memory, table data that distinguishes valid recording areas 100A from invalid recording areas 100B.

The first data recording method is based on the assumption that the disk 11 has eight data tracks 100, of which four tracks are valid recording areas 100A (N1=4), and the remaining four tracks are invalid recording areas 100B (N2=4), as is illustrated in FIG. 5. Thus, N1+N2=8. The recording magnetic field 200 emanating from the head 13 is applied at pitch P2 measured in the radial direction of the disk 11. Any valid recording area 100A and an invalid recording area 100B adjacent thereto are spaced from each other by a non-recording area 130.

As specified above, P1<P2. That is, the pitch P1 at which the data tracks 100 are arrange is shorter than the pitch P2 at which the recording magnetic field 200 is applied to the disk 11. As mentioned above, P1<TW. That is, the arrangement pitch P1 is shorter than the track width TW of the head 13, as measured in the radial direction of the disk 11. Further, P1/P2=½, or the ratio of P1 to P2 is ½, and P1<TW<P2. Hence, N1/(N1+N2)≦P1/TW, where N1>0 and N2>0.

In the first data recording method, wherein the valid recording areas 100A and invalid recording areas 100B are alternately arranged, the amount of data that can be recorded decrease to half the amount in the case where all data tracks 100 are valid recording areas 100A. Nonetheless, data can be reliably recorded on the DTR disk 11 though the track width TW of the head 13 is greater than the arrangement pitch P1, because invalid recording areas 100B are arranged, providing redundant recording areas. Therefore, the head 13 need not be discarded as defective, and the disk drive can be shipped as a product. This helps to raise the yield of the disk drive or the yield of the head 13 during the manufacture of the disk drive.

FIG. 6 is a diagram illustrating a second method of recording data on the DTR disk 11.

The second data recording method is based on the assumption that the disk 11 has nine data tracks 100, of which six tracks are valid recording areas 100A (N1=6), and the remaining three tracks are invalid recording areas 100B (N2=3), as is illustrated in FIG. 6. That is, N1+N2=9. In this case, P1/P2=⅔, or the ratio P1 to P2 is ⅔. Since P1<TW<P2, N1/(N1+N2)≦P1/TW, where N1>0 and N2>0.

In the second data recording method, the valid recording areas 100A and invalid recording areas 100B are alternately arranged. The amount of data that can be recorded decrease to two thirds (⅔) of the amount in the case where all data tracks 100 are valid recording areas 100A. Nonetheless, data can be reliably recorded on the DTR disk 11 though the track width TW of the head 13 is greater than the arrangement pitch P1, because invalid recording areas 100B are arranged, providing redundant recording areas. Therefore, the head 13 need not be discarded as defective, and can be used in the disk drive. This helps to raise the yield of the disk drive or the yield of the head 13.

FIG. 7 is a diagram illustrating a third method of recording data on the DTR disk 11.

The third data recording method is based on the assumption that the disk 11 has eight data tracks 100, of which six tracks are valid recording areas 100A (N1=6), and the remaining two tracks are invalid recording areas 100B (N2=2), as is illustrated in FIG. 7. That is, N1+N2=8. In this case, P1/P2=¾, or the ratio P1 to P2 is ¾. Since P1<TW<P2, N1/(N1+N2)≦P1/TW, where N1>0 and N2>0.

In the third data recording method, the valid recording areas 100A and invalid recording areas 100B are alternately arranged. Therefore, the amount of data that can be recorded decreases to three fourths (¾) of the amount in the case where all data tracks 100 are valid recording areas 100A. Nonetheless, data can be reliably recorded on the DTR disk 11 though the track width TW of the head 13 is greater than the arrangement pitch P1, because invalid recording areas 100B are arranged, providing redundant recording areas. Therefore, the head 13 need not be discarded as defective, and can be used in the disk drive. This helps to raise the yield of the disk drive or the yield of the head 13.

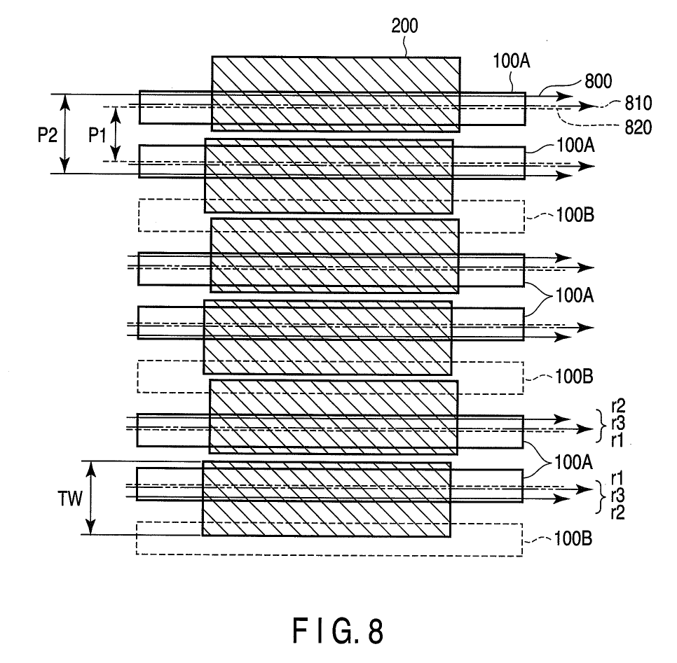

FIG. 8 is a diagram illustrating how the conditions of reproducing the data (magnetic signals) recorded in the valid recording areas 100A of the DTR disk 11 are set if the data has been recorded by the second data recording method.

Assume that the disk 11 has nine data tracks 100, of which six tracks are valid recording areas 100A (N1=6), and the remaining three tracks are invalid recording areas 100B (N2=3), as is illustrated in FIG. 8. That is, N1+N2=9. In this case, P1/P2=⅔, or the ratio P1 to P2 is ⅔. Since P1<TW<P2, N1/(N1+N2)≦P1/TW, where N1>0 and N2>0.

The reproduction radial position of any given valid recording area 100A is defined by a recording radial position 800 (r2) and the radial position 820 (r1) of the valid recording area 100A. The recording radial position 800 (r2) is not always identical to the position of the valid recording area 100A located at the radial position 820 (r1), because of the relationship P1<P2.

Therefore, the recorded data must be reproduced from any valid recording area 100A, at a position between the radial position 820 (r1) and recording radial position 800 (r2) of the valid recording area 100A. That is, if r1≧r2, the reproduction radial position 810 (r3) at which data should be reproduced from the valid recording area 100A is has relationship r1≧r3≧r2. In any other case, the reproduction radial position 810 (r3) is set to have relationship r1≦r3≦r2. The data can thereby be reproduced from any valid recording area 100A.

Three data recording methods for use in the embodiment have been described, in which the number N1 of valid recording areas 100A and the number N2 of invalid recording areas 100B are [4, 4], [6, 3] and [6, 2], respectively. In practice, however, the DTR disk 11 has 10000 or more tracks (N1+N2). Hence, far more other combinations of N1 and N2 are possible as well. The radio of N1 to N2 should be maximal so far as the limited track width TW allows. That is, the ratio of maximum N1 to minimum N2 should be set on the basis of the relationship (N1+N2)≦P1/TW.

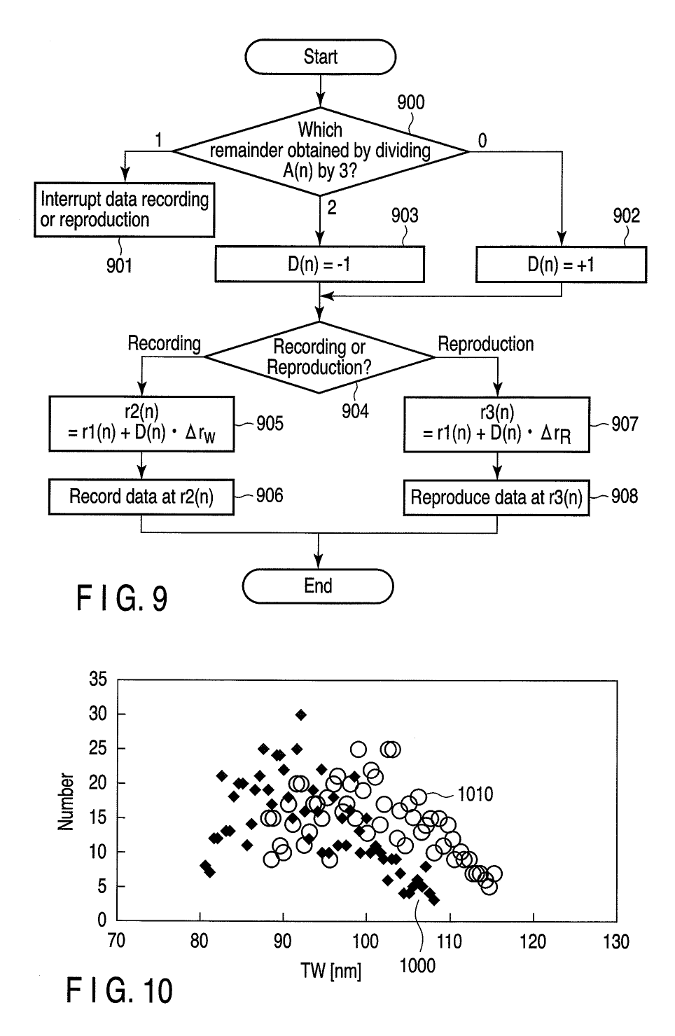

FIG. 9 is a flowchart illustrating a method of recording and reproducing data in the present the embodiment, which is particularly useful to the case where the conditions of playing back the data are set as explained with reference to FIG. 8.

For simplicity of explanation, assume that in the disk drive according to this embodiment, the track (cylinder) addresses A, which are serial numbers, manage all data tracks 100 and their center radial positions 820 (r1) in one-to-one relationship and are allocated to the innermost data track (having the smallest radius) to the outermost data track (having the largest radius), respectively.

In practice, before data is recorded or reproduced on or from the DTR disk 11, the disk drive according to this embodiment determines whether the data track 100 having the track address A(n) designated is a valid recording area 100A or an invalid recording area 100B. If the data track 100 is a valid recording area 100A, the MPU 22 calculates an offset for the recording radius r2(n) or the reproduction radial position r3(n) with respect to the center radial position r1 of the valid recording area 100A, in order to record or reproduce the data. How the data is recorded and reproduced will be explained below in detail, with reference to the flowchart of FIG. 9.

In response to an access request for recording or reproducing data, the MPU 22 determines whether the track address A(n) contained in the access request designates an invalid recording area 100B (Block 900). Assume that there are six valid recording areas 100A (N1=6) and three invalid recording areas 100B (N2=3). Then, N2:N1=2:1. The MPU 22 therefore sets one invalid recording area 110B for every two valid recording areas 100A. More specifically, the MPU 22 determines whether the remainder obtained by dividing the address A(n) corresponding to the data record/reproduction request, by 3 is “1.” If the remainder is “1,” the MPU 22 sets the physical address of the invalid recording area 100B (Block 901).

The offset value the head 13 has when it records or reproduce data will be explained. In FIG. 9, D(n) (either −1 or +1) is the sign that indicates the direction of the offset the head 13 has when it records or reproduces data, Δr_{W} is the absolute value of the offset the head 13 has when it records data, and Δr_{R} is the absolute value of the offset the head 13 has when it reproduces data.

The MPU 22 sets the physical addresses of the valid recording area 100A, setting D(n) to “+1” if the remainder obtained by dividing the track address A(n) by 3 is “0” (Block 902). If the remainder obtained by dividing the track address A(n) by 3 is “2,” the MPU 22 sets the physical address of the valid recording area 100A, setting D(n) to “−1” (Block 903). In the instance shown in FIG. 8, P1/P2=⅔. Therefore, in order to record data, the recording radial position r2 is set off from the center radial position r1 of the valid recording area 100A in which to record the data, toward the adjacent invalid recording area 100B by the absolute offset value Δr_{W}=(P1−P2)/2=(P1−2/3·P1)/2=1/6·P1. That is, the MPU 22 performs the calculation of “r2=r1+Δr_{W}” or “r2=r1−Δr_{W}” (Block 905). The absolute value [r2−r1] is [1/6·P1]. The MPU 22 then causes the head 13 to record the data at the recording radial position r2 of the valid recording area 100A designated by the track address A(n) contained in a recording request (Block 906).

In order to reproduce data, the reproducing radial position r3 is set off from the center radial position r1 of the valid recording area 100A from which to reproduce the data, toward the adjacent invalid recording area 100B by the absolute offset value Δr_{R}=0≦Δr_{W}. That is, the MPU 22 performs the calculation of “r3=r1+Δr_{R}” or “r3=r1−Δr_{R}” (Block 907). The MPU 22 then causes the head 13 to start reproducing the data at the reproducing radial position r3 of the valid recording area 100A designated by the track address A(n) contained in a reproduction request (Block 908). The offset value Δr_{R} is set to such a value that the signal reproduced may have the best quality possible under the condition “0≦Δr_{W}.” Here, Δr_{R}=1/12·P1.

The process of determining the direction of the adjacent invalid recording area 100B, or Blocks 902 and 903, will now be explained in detail.

The larger the track address number any data track 100 has, the larger radial position it will take. The invalid recording area 100B designated by the track address, for which the remainder obtained by dividing the track address A(n) by 3 is “1,” is located outside the valid recording area 100A, for which the remainder obtained by dividing the track address A(n) by 3 is “0,” or always located at a larger radial position on the DTR disk 11.

The recording radial position r1 of any valid recording area 100A designated by a track address, for which the remainder obtained by dividing the track address A(n) by 3 is “0,” is therefore set off from the center radial position of the valid recording area 100A by +Δr_{W}. Conversely, any valid recording area 100A designated by a track address, for which the remainder obtained by dividing the track address A(n) by 3 is “2,” is set off from the center radial position of the valid recording area 100A by −Δr_{W}, because an invalid recording area 100B is located adjacent to it, or positioned inside it. At the time of reproducing data, too, any valid recording area 100A designated by a track address that results in a remainder “0” when divided by 3 is set off by “+Δr_{R},” and any valid recording area 100A designated by a track address that results in a remainder “2” when divided by 3 is set off by “−Δr_{R}.”

In summary, whether data should be recorded or reproduced in or from a valid recording area 100A or an invalid recording area 100B is determined in the disk drive according to this embodiment, in accordance with the remainder obtained by dividing the track address A(n) contained in a data recording or reproduction request by 3. If the request designates an invalid recording area 100B, the MPU 22 will stop the recording or reproduction of data (Block 901).

On the other hand, if the request designates a valid recording area 100A, the MPU 22 will determine the direction of the adjacent invalid recording area 100B and store sign D(n) indicating this direction, in a memory. Then, the MPU 22 acquires a recording radial position r2 if the data should be recorded, or a reproduction radial position r3 if the data should be reproduced, and cause the head 13 to record the data at the recording radial position or to reproduce the data at the reproduction radial position.

The probability of setting invalid recording areas 100B in response to data recording or production request made at random for the data track 100 is N1/(N1+N2)=⅓ in the example of this embodiment. If any invalid recording area 100B is set, the data recording or reproduction will be interrupted. In the actual disk drive, the data recording or reproduction request does is made, not directly to the track addresses allocated to all data tracks 100 including the invalid recording areas 100B. That is, if a request for track address Ana is made, an address conversion will be performed, rounding up An=(N1+N2)/N2·Ana in the actual disk drive. The MPU 22 performs the address conversion immediately before determining whether the track address A(n) designates an invalid recording area 100B (Block 900), thereby preventing an access to any invalid recording area 100B. This prevents the interruption of the data recording or reproduction.

(Method of Manufacturing the Disk Drive)

A method of manufacturing the disk drive according to this embodiment will be explained in detail, with reference to FIGS. 10 to 14B.

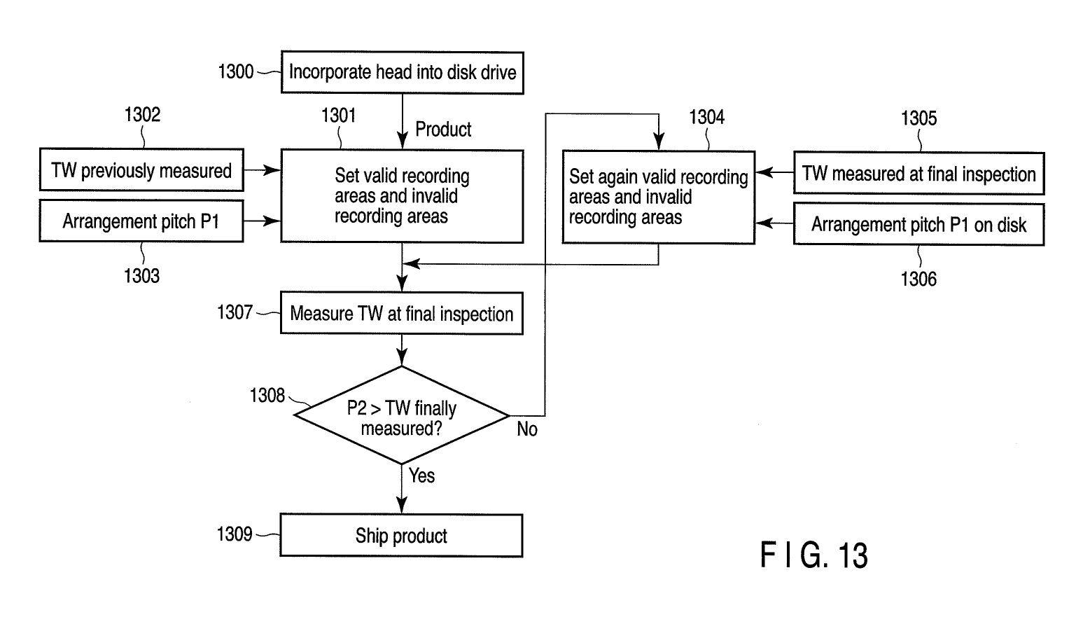

FIG. 13 is a flowchart outlining the method of manufacturing the disk drive, including the step of shipping the disk drive as a product.

First, the DTR disk 11 and the head 13 are incorporated into the main unit of the disk drive (Block 1300). At this point, servo data has been recorded in the servo areas 110 of the DTR disk 11. Alternatively, the servo data may be recorded in the servo areas 110 of the DTR disk 11 by performing a self-servo write (SSW) method, after the DTR disk 11 and head 13 have been incorporated.

Then, in the disk drive, valid recording areas 100A are set in the largest number N1 possible, and invalid recording areas 100B are set in the smallest number N2 possible, in the physical data tracks 100 formed on the DTR disk 11 now provided in the disk drive along with the head 13 (Block 1301). To be more specific, track addresses identifying the valid recording areas 100A and invalid recording areas 100B are stored in the memory provided in the disk drive. Prior to the step of setting the valid recording areas 100A and invalid recording areas 100B, the track width TW of the head 13 is measured (Block 1302), and the arrangement pitch P1 is set for data tracks 100 (Block 1303).

Next, a final inspection step is performed, measuring the track width TW of the head 13 incorporated in the disk drive (Block 1307). Further, a process is performed, determining whether the pitch P2 at which the recording magnetic field 200 is applied to the disk 11 exceeds the track width TW measured (Block 1308). If the pitch P2 exceeds the track width TW, the final inspection step is terminated. The disk drive is then shipped as a product (Block 1309).

If the results of the inspection is “no good,” or No in Block 1308, a process is performed, setting again valid recording areas 100A and invalid recording areas 100B (Block 1304). In this process, the track width TW measured in the final inspection step is utilized (Block 1305), and the arrangement pitch P1 measured beforehand is used, too (Block 1305). Moreover, the arrangement pitch P1 measured beforehand is utilized (Block 1306).

Manufactured by the method described above, the disk drive can be shipped as a product, which incorporates a DTR disk 11 having physical data tracks 100, including a largest number of valid recording areas 100A and a smallest number of invalid recording areas 100B. Whether the pitch P2 for applying the recording magnetic field to the disk 11 exceeds the track width TW measured in the final inspection step is determined on the basis of the lowest quality set for recorded data, as data is recorded in adjacent areas by applying the recording magnetic field to the disk 11 in the field applying pitch P2. More precisely, the signal-to-noise ratio or the error rate is measured after data has been recorded in some adjacent areas, thereby determining whether the pitch P2 exceeds the track width TW. The step of setting again valid recording areas 100A and invalid recording areas 100B is repeated until the field application pitch P2 exceeds the track width TW measured in the final inspection step (Blocks 1304, 1307 and 1308).

FIG. 10 is a diagram showing the distribution of the track width TW.

The head 13 is manufactured in such complex and precise steps as the most advanced semiconductor devices are manufactured. The dimensional features of the head 13 inevitably deviate from the design values, as well known in the art. Such deviation in dimensional features is compensated for in the disk drive according to the present embodiment. Therefore, the head 13 need not be discarded as defective and can be used in the disk drive. This can lower the change of discarding the head 13.

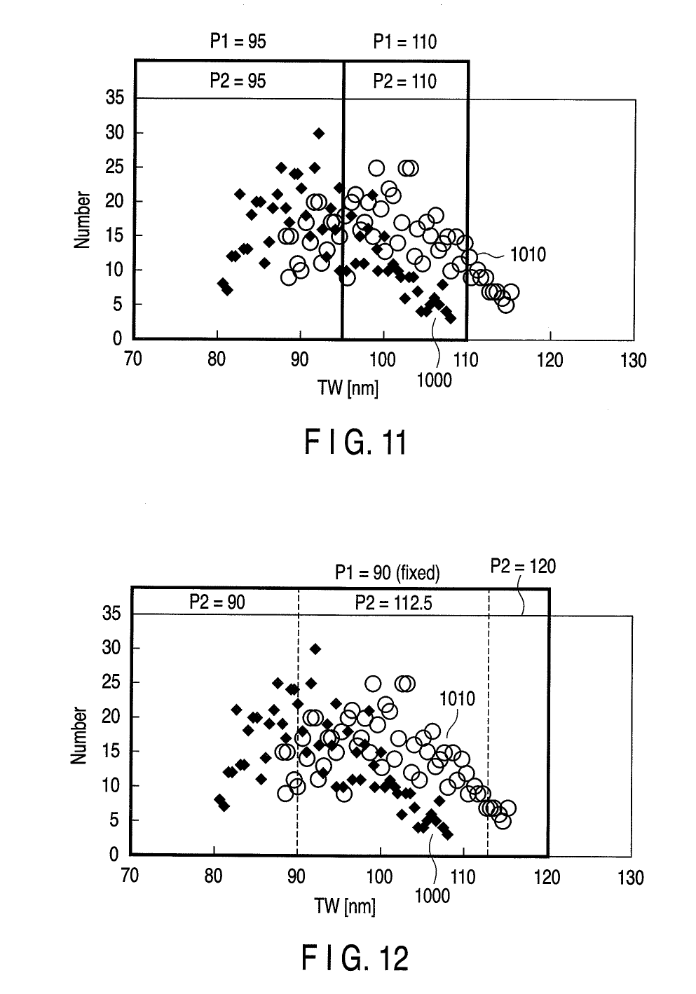

FIG. 11 is a diagram showing the relationship between the head 13 having the distribution of track width TW, determined by an inspection apparatus and the DTR disk 11 incorporated in the drive disk. Generally, the field application pitch P2 of the head 13 should be identical to the density of the discrete tracks formed, i.e., arrangement pitch P1 of data tracks 100. However, if the dimensional features of the head 13, particularly track width TW, deviate from the design values, the track density of the DTR disk 11 associated with the head 13 cannot be adjusted.

Some kinds of DTR disks having different track densities and the same arrangement pitch P1 were produced. Heads having different track widths TW were also produced. The DTR disks were used in combination with the heads, respectively, providing disk drives, each having the largest storage capacity possible. More precisely, two types of DTR disks were produced. The disks of one type had arrangement pitch P1 of 95 nm, and those of the other type had arrangement pitch P1 of 110 nm, as shown in FIG. 11. The disks having arrangement pitch P1 of 95 nm (267 kTPI) were incorporated into disk drives, in combination with the heads having track width TW less than 95 nm. The disks having arrangement pitch P1 of 110 nm (231 kTPI) were incorporated into disk drives, in combination with the heads having track width TW exceeding 95 nm. That is, two types of heads were produced, one type having a track width TW of less than 95 nm, and the other type having track width TW exceeding 95 nm. The disk drives, each incorporating a disk having arrangement pitch P1 of 95 nm and a head having track width TW less than 95 nm, and the disk drives, each incorporating a disk having arrangement pitch P1 of 110 nm and a head having track width TW exceeding 95 nm, were driven in the inspection step.

In this experiment, however, the cost concerning the disks was high because disks were produced in two types. Further, since the margin that the arrangement pitch P1 had with respect to the track width TW was insufficient, many disk drives having a disk having arrangement pitch P1 of 95 nm and a head having track width TW exceeding 95 nm, particularly the track width TW being a little over 95 nm, were found defective in the final inspection since the margin the arrangement pitch P1 was insufficient with respect to the track width TW. This is because the track width TW before the drive shipment differed a little from the value measured immediately before, depending on the conditions in which the track width TW was measured and to which lot the head belongs. Consequently, any disk drive found defective in the final inspection could not shipped, because the drive performance cannot be guaranteed if the drive is found not to have a track width TW of a desirable value immediately before the shipment.

Any disk drive that had a head of Lot 1010 could not use a disk having arrangement pitch P1 of 110 nm if the head had a track width TW exceeding 110 nm. As a result, heads having a track width TW exceeding 110 nm must be discarded as defective.

FIG. 12 is a diagram showing the relationship between the type of the head incorporated in the disk drive and the field application pitch P2 set for the disk.

Disks of the same type were produced, each having the arrangement pitch P1 of 90 nm. Heads were produced as Lot 1000, in two types. The heads of one type had a track width TW of less than 90 nm. The heads of the other type had a track width TW exceeding 90 nm, but less than 112.5 nm (90 nm<TW<111.5 nm). Some of the disks, having field application pitch P2 equal to arrangement pitch P1, were incorporated into disk drives, together with the heads having track width TW of less than 90 nm, thus providing disk drives having track density of 283 kTPI. The other disks having field application pitch P2 of 112.5 nm were incorporated into disk drives, together with the heads having track width TW exceeding 90 nm but less than 112.5 nm, thus providing disk drives having track density of 226 kTPI.

The disk drives manufactured in this method need only disks of only one type. This helps to reduce the cost of producing disks. In addition, disk drives can be manufactured without discarding the heads, because of the heads of Lot 1000, those having a track width TW exceeding 112.5 nm apply a recording magnetic field at pitch P2 of 120 nm and therefore help to provide disk drives having track density of 212 kTPI, without discarding any head produced.

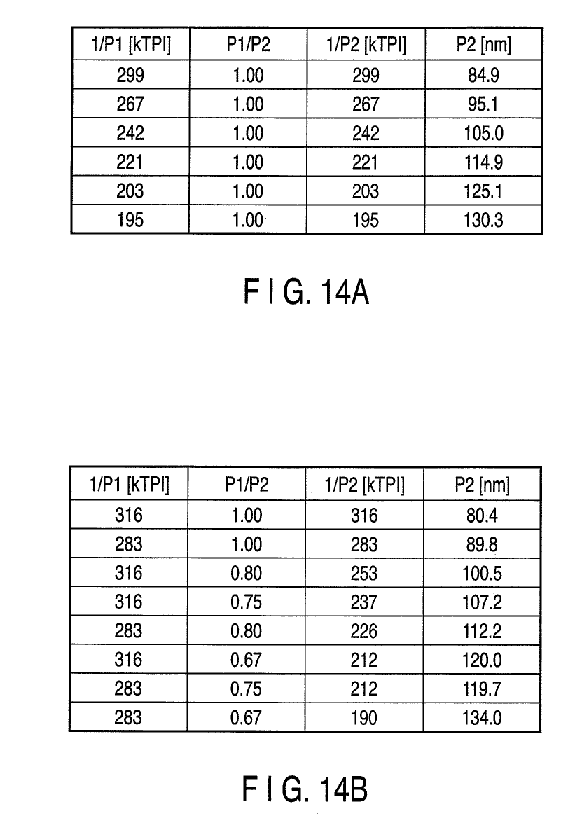

FIG. 14B is a table illustrating a method of selecting a head from those that have track widths TW of 75 nm to 130 nm, and of adjusting the track density in a disk drive that has a track width TW of about 10 nm. Only two types of disks are produced. The number N1 of valid recording areas 100A and the number N2 of invalid recording areas 100B are set to appropriate values, so that the ratio of the arrangement pitch P1 in radial direction to the field application pitch P2 may be: P1/P2={1, 0, 8, 0, 75, 0.67}.

FIG. 14A is a table illustrating a conventional method, in which disks different in arrangement pitch P1 must be produced, each for a specific track density, and each disk is used in association with a head of one type. Consequently, disks must be produced in six types. The embodiment described above is designed to use a DTR disk 11 that is a 1.8-inch disk that has arrangement pitch P1 of 90 nm (282 kTPI), data tracks having a width 60 mn, and non-recording areas 130 having a width of 30 mn.

As has been described, the present embodiment can increase the yield of heads even if the recording width of the head deviates from the design value, because the track density of the DTR disk is adjusted.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk drive comprising:
a disk having a disk substrate and tracks on the disk substrate, each track comprising recording areas which comprise magnetic layers and non-recording areas which comprise non-magnetic layers aligned in a radial direction of the disk, and the recording areas of each track comprising M valid recording areas and N invalid recording areas and a ratio M/N is constant where M and N are natural numbers; and
a reader and writer configured to use a head, and to record in the valid recording area or to reproduce data from the valid recording areas.

2. The disk drive of claim 1, wherein the tracks in the disk are aligned in the radial direction of the disk, at a pitch shorter than a pitch at which the head applies a recording magnetic field to the disk in order to record data, as the head moves in the radial direction of the disk.

3. The disk drive of claim 2, wherein a track width of the head is smaller than the pitch at which the head applies the recording magnetic field to the disk in order to record data.

4. The disk drive of claim 2, wherein the pitch between the tracks in the radial direction of the disk is smaller than a track width of the head.

5. The disk drive of claim 1, wherein a pitch between the tracks in the radial direction is smaller than a track width of the head, the track width of the head is smaller than a pitch at which the head applies a recording magnetic field to the disk in order record data, as the head moves in the radial direction of the disk.

6. The disk drive of claim 1, wherein a pitch between the tracks in the radial direction is smaller than a track width of the head, each of the tracks comprises more valid recording areas than the invalid recording areas, the valid and invalid recording areas being aligned in the radial direction of the disk, a track width of the head is smaller than a pitch at which the head applies a magnetic field to record data on the disk as the head moves in the radial direction of the disk.

7. The disk drive of claim 3, wherein each of the tracks comprises more valid recording areas than invalid recording areas, and is configured to satisfy the following condition:
N1/(N1+N2)≦P1/TW
where N1 is the number of valid recording areas, N2 is the number of invalid recording areas, TW is the track width, and P1 is the pitch at which the tracks are aligned in the radial direction of the disk.

8. The disk drive of claim 1, wherein the valid recording areas of the disk comprise r1 as a physical radial position, r2 as a recording radial position at which to record data, and r3 as a reproduction radial position at which to reproduce data, and the disk is configured to satisfy the following relationship:
r1≧r3≧r2;
if r1 is equal to or larger than r2, and the disk is configured to satisfy the following relationship:
r1≦r3≦r2;
if r2 is larger than r2.

9. The disk drive of claim 1, wherein the reader and writer is configured to determine whether the track of the disk designated by a track address in an access request is an invalid recording area, and to interrupt data recording or data reproduction if the track is determined as the invalid recording area.

10. A method of recording and reading data of a disk drive having a disk that comprises a disk substrate and tracks on the disk substrate, each track comprising recording areas which comprise magnetic layers and non-recording areas which comprise non-magnetic layers in a radial direction of the disk, and the data recording areas of each track comprising M valid recording areas and N invalid recording areas and a ratio M/N is constant where M and N are natural numbers, the method comprising:
determining whether a track of the disk designated by a track address in an access request is an invalid recording area;
interrupting data recording or data reproducing if the track is determined as the invalid recording area; and
recording or reproducing data in or from a valid recording area, based on the result of determining.

11. A method of manufacturing a disk drive incorporating a discrete track disk and a head, the method comprising:
setting a ratio of numbers of valid recording areas to invalid recording areas, based on a track width of the head and a pitch between data tracks on the disk;
determining in a inspection whether a pitch at which the head applies a recording magnetic field is larger than the a track width; and
setting a new ratio of the numbers of the valid recording areas to the invalid recording areas, if the pitch at which the head applies a recording magnetic field is smaller than the track width.
